(19) United States
(12) Patent Application Publication
(10) Pub. No.: US 2017/0236556 A1
(43) Pub. Date: Aug. 17, 2017

(54) DISK DRIVE HAVING A FILTER AND A FILTER FOR A DISK DRIVE

(71) Applicant: KABUSHIKI KAISHA TOSHIBA, Tokyo (JP)

(72) Inventors: Yasuhiko KATO, Setagaya Tokyo (JP); Yoshihiko NAKAMURA, Yokohama Kanagawa (JP)

(21) Appl. No.: 15/233,762

(22) Filed: Aug. 10, 2016

Related U.S. Application Data
(60) Provisional application No. 62/295,393, filed on Feb. 15, 2016.

(51) Int. Cl. G11B 33/14; B01D 39/08; B01D 39/14; B01D 29/56; B01D 35/02

(52) U.S. Cl. CPC G11B 33/146; B01D 29/56; B01D 35/02; B01D 39/14; B01D 39/08; B01D 2239/065

(57) ABSTRACT

A disk drive includes a housing, a disk recording medium disposed in the housing, and a plurality of filters disposed along a flow channel formed in the housing and overlapped with each other. Each of the filters including an outer member formed of an electrostatic woven fabric and electrostatic non-woven fibers contained in an enclosed space formed by the outer member.

### CROSS-REFERENCE TO RELATED APPLICATION

This application is based upon and claims the benefit of priority from Provisional Application No. 62/295,393, filed Feb. 15, 2016, the entire contents of which are incorporated herein by reference.

### FIELD

Embodiments described herein relate generally to a disk drive having a filter and a filer for a disk drive.

### BACKGROUND

A disk drive such as a hard disk drive (HDD) generally includes a magnetic disk provided in a housing, a spindle motor which supports and rotates the magnetic disk, an actuator assembly which supports a magnetic head, and a voice coil motor which drives the actuator assembly. A disk drive of one type further includes a filter for catching dust produced in the housing as the magnetic disk rotates. A filter of one type catches the dust with an electrostatic force.

### BRIEF DESCRIPTION OF THE DRAWINGS

FIG. 1 is a perspective view of an inner structure of a hard disk drive (HDD) according to a first embodiment.

FIG. 2 is a plan view of the inner structure of the HDD.

FIG. 3 is an enlarged perspective view of a portion of the HDD in which a circulation filter is disposed.

FIG. 4 is an exploded perspective view of the circulation filter and the portion of the HDD shown in FIG. 3.

FIG. 5 is a cross-sectional view of the circulation filter according to the first embodiment.

FIG. 6 is an enlarged perspective view of a portion of an HDD in which a circulation filter according to a second embodiment is disposed.

FIG. 7 is an exploded perspective view of the circulation filter according to the second embodiment and the portion of the HDD in which the circulation filter is disposed.

FIG. 8 is a cross-sectional view of the circulation filter according to the second embodiment.

FIG. 9 is a perspective view of the circulation filter according to the second embodiment in an expanded state.

FIG. 10 is a cross-sectional view of the circulation filter according to the second embodiment taken along line X-X in FIG. 9.

FIG. 11 is a perspective view of a circulation filter according to a third embodiment in an expanded state.

FIG. 12 is a cross-sectional view of the circulation filter according to the third embodiment.

### DETAILED DESCRIPTION

Various embodiments will be described hereinafter with reference to the accompanying drawings. In general, according to an embodiment, a disk drive includes a housing, a disk recording medium disposed in the housing, and a plurality of filters disposed along a flow channel formed in the housing and overlapped with each other. Each of the filters including an outer member formed of an electrostatic woven fabric and electrostatic non-woven fibers contained in an enclosed space formed by the outer member.

As a disk drive, a hard disk drive (HDD) is described in detail according to various embodiments.

### First Embodiment

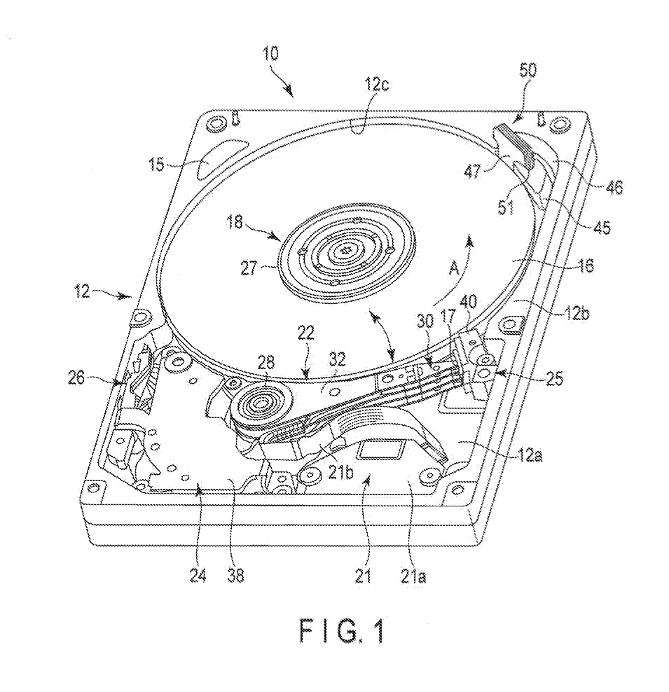

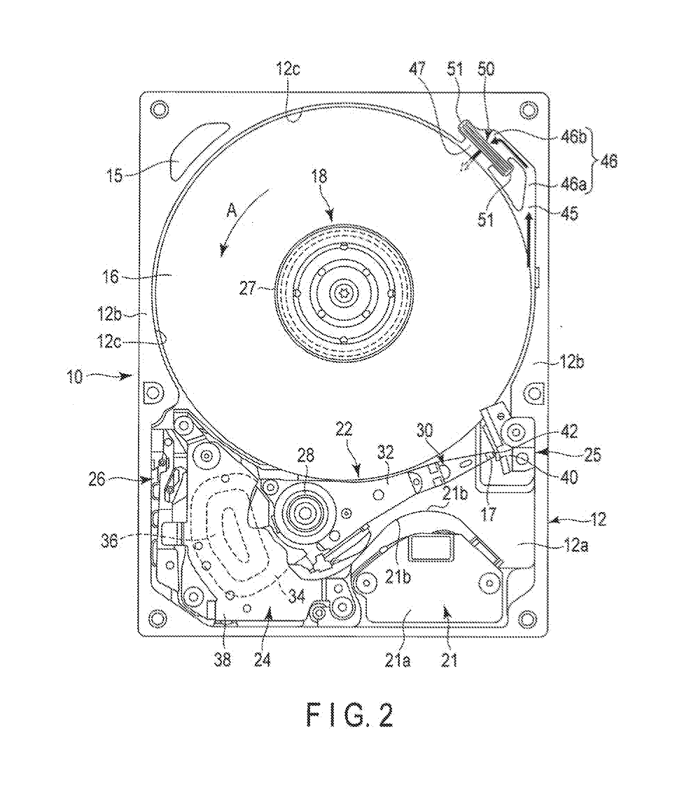

FIG. 1 is a perspective view of an inner structure of an HDD according to a first embodiment. FIG. 2 is a plan view of the inner structure of the HDD. As shown in FIG. 1 and FIG. 2, the HDD includes a housing 10. The housing 10 includes a base 12 and a top cover (not shown). The base 12 has a shape of a rectangular box in which the upper surface is open. The upper end opening of the base 12 is closed by the top cover. The base 12 includes a rectangular bottom wall 12a, and a sidewall 12b standing along the peripheral edges of the bottom wall 12a.

In the housing 10, for example, three magnetic disks 16 are disposed as a recording medium. Further, in the housing 10, a spindle motor 18 is disposed as an actuator which supports and rotates the magnetic disks 16. The spindle motor 18 is disposed on the bottom wall 12a. Each of the magnetic disks 16 has a diameter of, for example, 65 millimeters (2.5 inches), and has a magnetic recording layer on the upper surface (one surface) and the lower surface (the other surface). The magnetic disks 16 are fit on a hub (not shown) of the spindle motor 18 concentrically, and are clamped by a clamp spring 27 to be secured to the hub. In this manner, the magnetic disks 16 are supported at positions parallel to the bottom wall 12a of the base 12. The magnetic disks 16 are rotated by the spindle motor 18 at a predetermined speed in the direction of arrow A in FIGS. 1 and 2.

In the housing 10 are provided a plurality of magnetic heads 17, each of which writes and reads data relative to the corresponding one of the magnetic disks 16, and an actuator assembly 22 which supports the magnetic heads 17 so as to be movable relative to the magnetic disks 16. Further, in the housing are provided a voice coil motor (VCM) 24, a ramp loading mechanism 25, a latch mechanism 26, and a flexible printed circuit (FPC) board unit 21. The VCM 24 rotates the actuator assembly 22 and sets the position of the actuator assembly 22. The ramp loading mechanism 25 holds the magnetic heads 17 at unloaded positions away from the magnetic disks 16 when the magnetic heads 17 move to the outermost periphery of the magnetic disks 16. The latch mechanism 26 holds the actuator assembly 22 at a retreating position when, for example, an impact is made on the HDD. Electronic components such as a conversion connector are mounted on the FPC board unit 21.

A printed circuit board (control circuit board; not shown) is attached to the outer surface of the bottom wall 12a of the base 12. This printed circuit board controls the operation of the spindle motor 18 and controls the operations of the VCM 24 and the magnetic heads 17 via the flexible printed circuit board unit (referred to as an FPC unit) 21. A circulation filter (collection filter) 50 for collecting dust which is produced in the housing by operation of the actuator such as the spindle motor 18 is provided near the sidewall 12b of the base 12, and is located outside the magnetic disks 16. A respiratory filter 15 for removing dust, humidity, and gaseous components of external air flowing into the housing 10 through a vent (not shown) formed on the top cover is provided near the sidewall 12b.

As shown in FIG. 1 and FIG. 2, the actuator assembly 22 includes a rotatable bearing unit 28, four arms 32 provided in the bearing unit 28 in a stacked state, a suspension assembly extending from each arm 32, and the magnetic heads 17 supported by the suspension assemblies 30. The actuator assembly 22 is rotatably supported on the bottom wall 12a around the pivot of the bearing unit 28.

The actuator assembly 22 comprises a supporting frame 34 extending from the bearing unit 28 in a direction opposite to the arms 32. By the supporting frame 34, a voice coil 36, which is a part of the VCM 24, is supported. The voice coil 36 is located between a pair of yokes 38. One of the yokes 38 is secured onto the base 12. The VCM 24 is formed of the voice coil 36, the yokes 38, and a magnet secured to one of the yokes 38.

The ramp loading mechanism 25 comprises a ramp 40 provided on the bottom wall 12a of the base 12 outside the magnetic disks 16, and a tab 42 extending from the distal end of each suspension assembly 30. The ramp 40 is located on the downstream side of the bearing unit 28 with respect to the direction of rotation A of the magnetic disks 16. When the actuator assembly 22 rotates, and the magnetic heads 17 rotate to retreating positions outside the magnetic disks 16, each tab 42 is engaged with a ramp surface formed on the ramp 40. Subsequently, each tab 42 is drawn up by the slope of the ramp surface and unloads the magnetic heads 17.

The FPC unit 21 comprises a main body 21a formed by a flexible printed circuit board. The main body 21a is secured to the bottom wall 12a of the base 12. Electronic components such as a conversion connector are mounted on the main body 21a. The FPC unit 21 comprises a relay flexible printed circuit board (referred to as a relay FPC) 21b extending from the main body 21a. The extension end of the relay FPC 21b is connected to the vicinity of the bearing unit 28 of the actuator assembly 22 and is further electrically connected to the magnetic heads 17 via interconnect members (flexures; not shown) provided on the arms 32 and the suspension assemblies 30.

As shown in FIG. 1 and FIG. 2, the sidewall 12b which occupies substantially half the area of the sidewall 12b in the longitudinal direction of the base 12 is located around the outer circumference of the magnetic disks 16. This sidewall 12b has an inner surface 12c. The inner surface 12c is formed in a circular shape along the outer circumference of the magnetic disks 16 and faces the outer circumference of the magnetic disks 16 with a small intervening space. The circulation filter 50 is provided in, out of four corner portions of the base 12, a corner portion which is the closest to the magnetic heads 17 or the ramp 40 on the downstream side of the magnetic heads 17 or the ramp 40 with respect to the direction of rotation A of the magnetic disks 16. The base 12 comprises a guide flow channel (flow channel) 46 which guides the airflow produced by the rotation of the magnetic disks 16 to the circulation filter 50. The guide flow channel 46 is defined by a guide groove formed on the sidewall 12b and having a depth perpendicular to the bottom wall 12b.

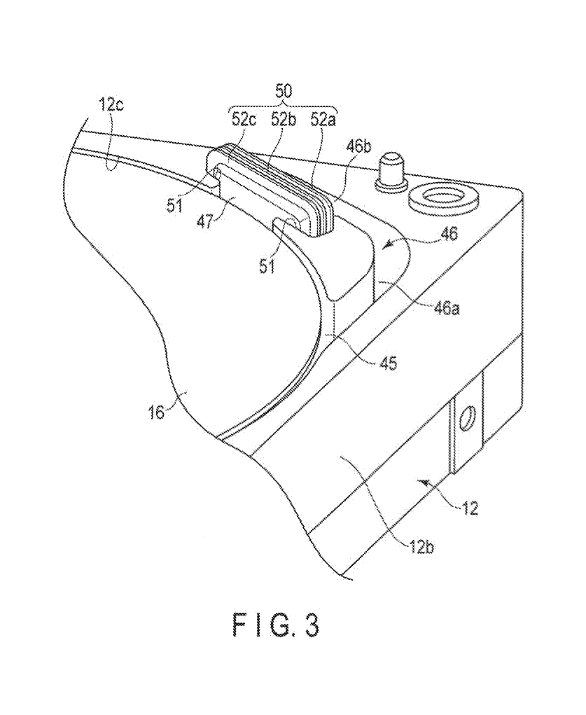

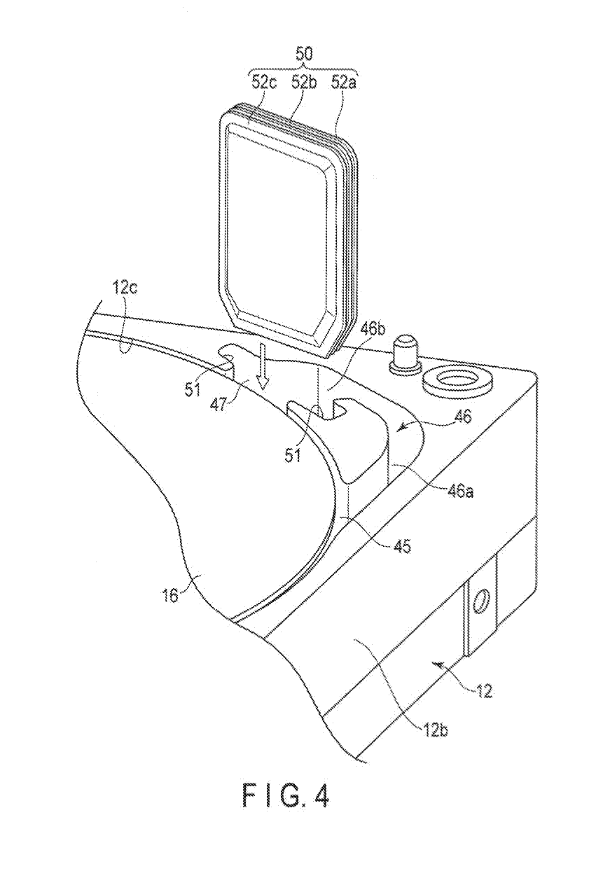

FIG. 3 is an enlarged perspective view of a portion of the HDD in which the circulation filter is provided. FIG. 4 is an exploded perspective view showing the circulation filter and the portion of the HDD in which the circulation filter is disposed.

As shown in FIGS. 1 to 4, the guide flow channel 46 includes an inlet 45 which opens on the inner surface 12c of the sidewall 12b, a first flow channel 46a which extends from the inlet 45 in the tangential direction of the outer circumference of the magnetic disks 16, and a second flow channel 46b which extends from the first flow channel 46a toward a center of rotation of the magnetic disks 16. The second flow channel 46b includes an outlet 47 which opens on the inner surface 12c toward the magnetic disks 16. The opening width of the outlet 47 in a direction perpendicular to the second flow channel 46b and parallel to the bottom wall 12a of the base 12 is twice or more greater than the opening width of the inlet 45 in a direction perpendicular to the first flow channel 46a and parallel to the bottom wall 12a of the base 12. In the present embodiment, the first flow channel 46a extends so as to be curved in its middle portion. The second flow channel 46b extends in a direction substantially perpendicular to the first flow channel 46a and extends in the radial direction of the magnetic disks 16 on a plane parallel to the bottom wall 12a of the base 12.

The sidewall 12b of the base 12 includes a pair of slits (or fitting grooves) 51 for fitting the circulation filter 50. The fitting grooves 51 are formed on both sides of the second flow channel 46b in the width direction of the second flow channel 46b (in other words, in a direction perpendicular to the second flow channel 46b or the direction of the airflow and parallel to the bottom wall 12a of the base 12) near the magnetic disks 16, in other words, near the outlet 48. The fitting grooves 51 open to the second flow channel 46b and to the upper surface of the sidewall 12b. Thus, the fitting grooves 51 face each other with the second flow channel 46b in between, and are arranged in a direction perpendicular to the second flow channel 46b or the tangential direction of the outer circumference of the magnetic disks 16. The width of each fitting groove 51 (in the direction of the airflow of the second flow channel 46b and in a direction parallel to the bottom wall 12a of the base 12) is set such that a plurality of filter members (described below) can be fit.

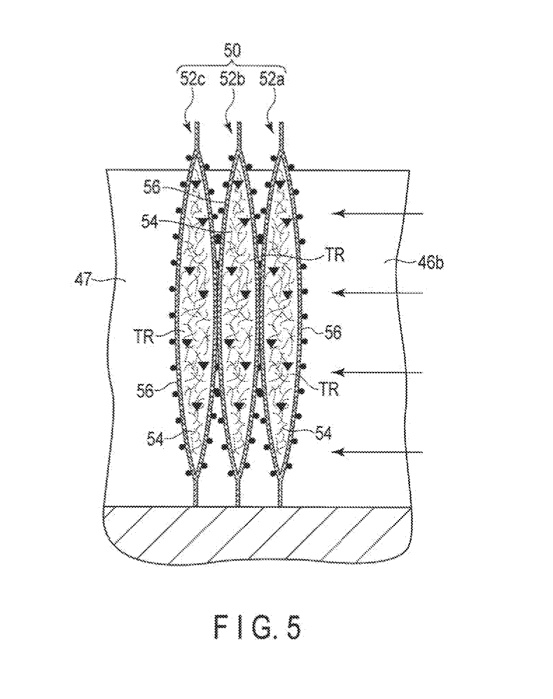

FIG. 5 schematically illustrates a cross-sectional view of the circulation filter 50. As shown in FIGS. 3 to 5, the circulation filter 50 is arranged in the second flow channel 46b in a state where both end portions of the circulation filter 50 are fit in the fitting grooves 51 of the sidewall 12b. The circulation filter 50 is provided across the second flow channel 46b and blocks the second flow channel 46b and the outlet 47.

In the present embodiment, the circulation filter 50 includes a plurality of, for example, three independent filter members 52a, 52b, and 52c. Filter members 52a, 52b and 52c have the same shape and the same structure. Each of filter members 52a, 52b, and 52c includes a filled area TR filled with electrostatic fibers such as electret nonwoven fabric 54, and an air-permeable outer envelope 56 which covers the filled area TR. The filled area TR and the outer envelope 56 are formed in a substantially rectangular shape, and are formed in a mat shape as a whole. As described below, the outer envelope 56 includes a first outer envelope which covers a surface side of the filled area TR, and a second outer envelope which covers the opposite surface side of the filled area TR. The outer envelope 56 is formed in a bag shape by bonding, for example, welding the circumferential portion of the first outer envelope to that of the second outer envelope. As the air-permeable outer envelope 56, for example, resin woven fabric such as polyethylene terephthalate (PET) woven fabric may be used.

In each of filter members 52a, 52b, and 52c, the center region including the filled area TR is referred to as a first portion having a first thickness. The region of the outer envelope 56 located around the filled area TR is referred to as a second portion having a second thickness less than the first thickness.

The three filter members 52a, 52b, and 52c are arranged in the second flow channel 46b in a state where both end portions of each filter member are fit in the fitting grooves 51. Filter members 52a, 52b, and 52c are provided across the second flow channel 46b, and block the second flow channel 46b and the outlet 47. Further, filter members 52a, 52b, and 52c overlap each other. In this case, as shown in FIG. 5, the center regions (at least a part of the first portion) adjacent filter members 52a, 52b, and 52c are in contact with each other. However, the circumferential portions of filter members 52a, 52b, and 52c face each other with a space therebetween. In this manner, most of the outer envelope 56 of each of filter members 52a, 52b, and 52c are exposed to the second flow channel 46b and allowed to be in contact with the air flowing in the second flow channel 46b. The number of filter members is not limited to three, and may be two, four or more. The number of filter members may be appropriately increased or decreased in accordance with the width of the fitting grooves 51 or the installation space.

In the HDD having the above structure, an airflow is generated in the rotational direction A when the magnetic disks 16 rotate in the direction A at high speed. A part of the air is introduced into the first flow channel 46a through the inlet 45 of the guide flow channel 46, and flows through the first flow channel 46a in the tangential direction of the magnetic disks 16. Further, the air flows from the first flow channel 46a and passes through the second flow channel 46b in a direction toward the center of rotation of the magnetic disks 16, in other words, in the radial direction of the magnetic disks 16. At this time, the air passes through the circulation filter 50. The dust contained in the air is collected by the circulation filter 50. Subsequently, the air is returned from the outlet 47 toward the magnetic disks 16 and joins the air flowing along the outer circumference of the magnetic disks 16.

As shown in FIG. 5, when collecting dust, a part of the dust contained in the airflow is attracted to the surface of each of filter members 52a, 52b and 52c, in other words, to the external side of the outer envelope 56, by static electricity. In this manner, a part of the dust is caught. The other part of the dust is caught by the electret nonwoven fabric 54 when passing through the filled area TR of each of filter members 52a, 52b, and 52c. In the present embodiment, the circulation filter 50 includes a plurality of independent filter members 52a, 52b, and 52c. Most of the surfaces of these filter members are exposed to the second flow channel 46b. Thus, it is possible to increase the effective surface area of the circulation filter 50 (in other words, the area of the surface which is allowed to be in contact with the airflow, or the area of the surface exposed to the flow channel 46). The collection efficiency with electrostatic attraction can be improved. In this manner, the dust can be caught even in a portion which cannot obtain a sufficient speed for the airflow.

To improve efficiency of dust collection of the circulation filter, the density of the filter may be increased by increasing the thickness of the filter. However, the amount of air passing through the circulation filter is not increased in a portion where the speed of flow is low. For that reason, the collection efficiency is difficult to improve by changing the thickness of the filter. In the present embodiment, the circulation filter 50 includes a plurality of filter members 52a, 52b and 52c. Thus, it is possible to increase the effective surface area of the circulation filter and improve the collection efficiency with electrostatic attraction. For example, in the present embodiment, the collection efficiency of the circulation filter 50 is improved by 16%.

As described above, according to the present embodiment, it is possible to provide a circulation filter (collection filter) having a high efficiency for dust collection, and a disk drive including the circulation filter.

Next, an HDD and a dust collection filter according to another embodiment will be described. In the embodiments described below, elements same as those of the first embodiment are denoted by the same reference numbers or symbols, and detailed description of these elements are omitted or simplified. Elements different from those of the first embodiment are mainly described in detail.

### Second Embodiment

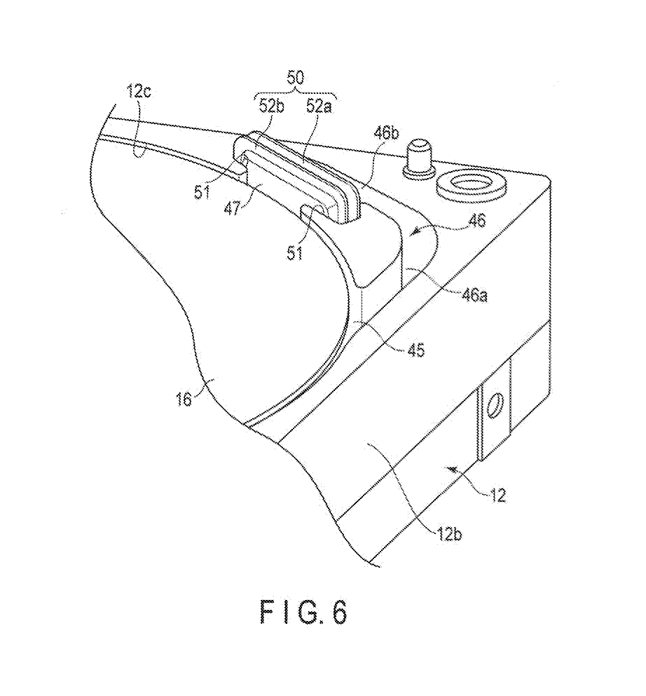

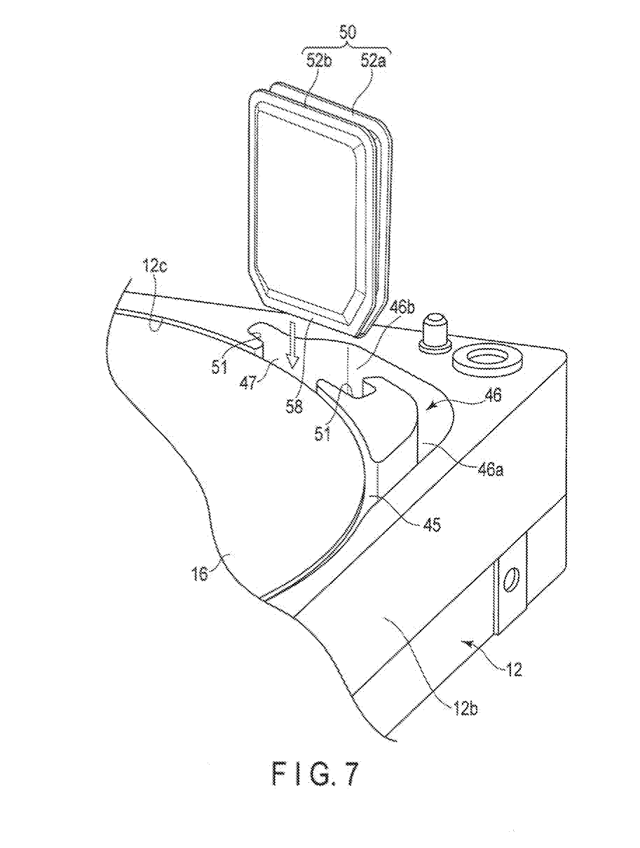

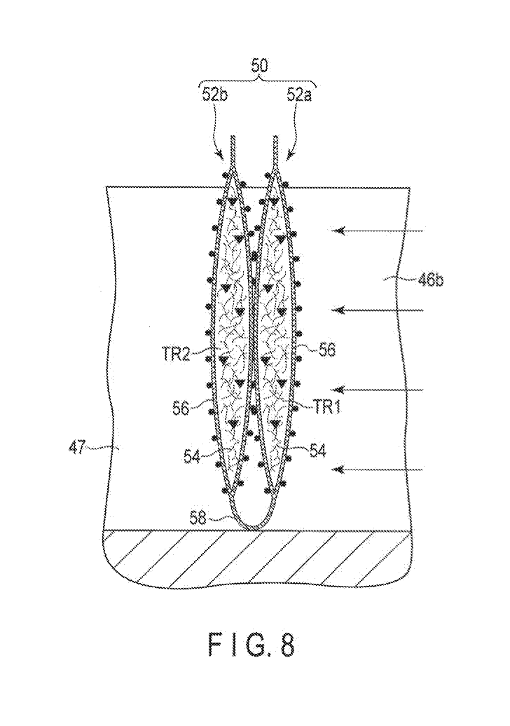

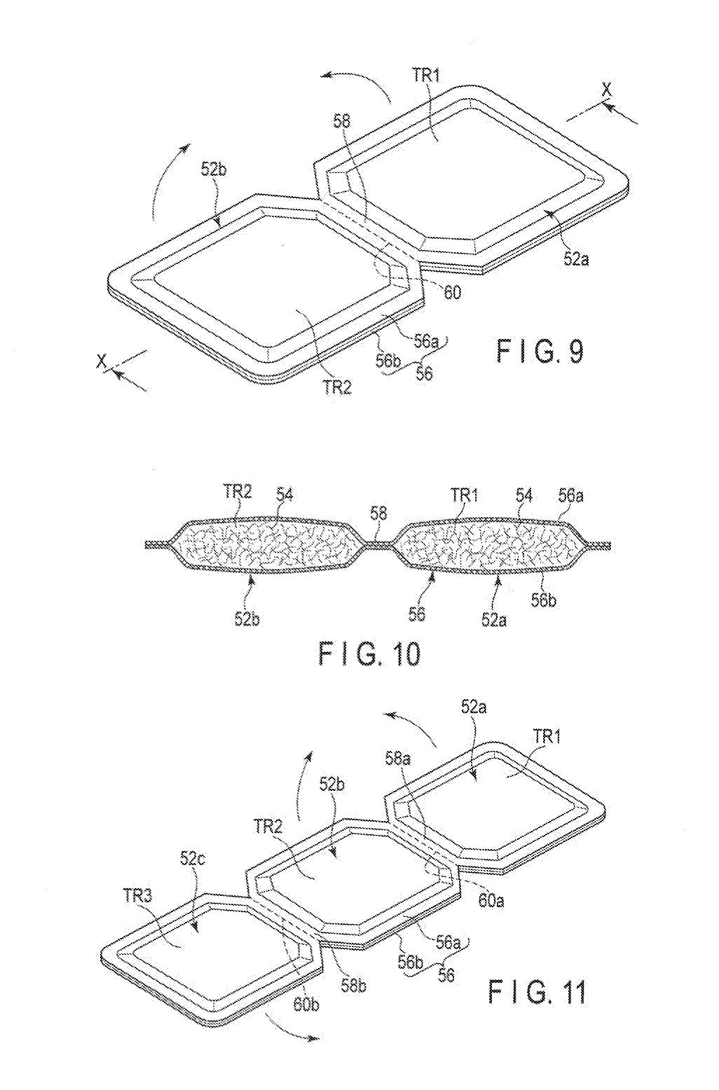

FIG. 6 is an enlarged perspective view of a portion of the HDD in which a circulation filter according to a second embodiment is disposed. FIG. 7 is an exploded perspective view of the circulation filter and the portion of the HDD shown in FIG. 6. FIG. 8 is a cross-sectional view of the circulation filter in a state disposed in the HDD. FIG. 9 is a perspective view of the circulation filter in an expanded state. FIG. 10 is a cross-sectional view of the circulation filter taken along line X-X of FIG. 9.

According to the present embodiment, a circulation filter 50 has a structure in which a plurality of filter members is connected integrally. The filter members are bent at a predetermined position so as to overlap each other. As shown in FIGS. 8 to 10, the circulation filter 50 is formed by connecting a first filter member 52a and a second filter member 52b. The first filter member 52a and the second filter member 52b include a first filled area TR1 and a second filled area TR2, respectively, filled with electrostatic fibers such as electret nonwoven fabric 54. The first filter member 52a and the second filter member 52b include a common outer envelope 56 which covers the first and second filled areas TR1 and TR2 and is air permeable. The first and second filled areas TR1 and TR2 and the outer envelope 56 are formed in a substantially rectangular shape, and are formed in an elongated mat shape as a whole.

The outer envelope 56 includes a first outer envelope 56a which covers a surface side of the first and second filled areas TR1 and TR2, and a second outer envelope 56b which covers the opposite surface side of the first and second filled areas TR1 and TR2. The outer envelope 56 is formed in a bag shape by bonding, for example, welding the first and second outer envelopes 56a and 56b together in the outer circumferences of the first and second filled areas TR1 and TR2. A partition 58 is formed by bonding the first and second outer envelopes 56a and 56b together between the first filled area TR1 and the second filled area TR2. The first filter member 52a and the second filter member 52b are connected by the partition 58. To bend the partition 58 easily, perforations or slits 60 may be formed in the partition 58.

As the air-permeable outer envelope 56, resin woven fabric such as polyethylene terephthalate (PET) woven fabric may be used.

As shown in FIG. 6, FIG. 7, and FIG. 8, the circulation filter 50 is bent at the partition 58. The two filled areas, specifically, the first and second filled areas TR1 and TR2, face each other. The circulation filter 50 is inserted into and fit in fitting grooves 51 of a base 12 of an HDD from the partition 58 side in a bent state. In this manner, the first and second filter members 52a and 52b of the circulation filter 50 are disposed across a second flow channel 46b and block the second flow channel 46b and an outlet 47. Further, the first and second filter members 52a and 52b are provided so as to overlap each other in the direction of the airflow of the second flow channel 46b. In this case, as shown in FIG. 8, the center regions of the first and second filter members 52a and 52b are in contact with each other. However, the circumferential portions of the filter members 52a and 52b face each other with a space therebetween. As a result, most of the outer envelope 56 of the first and second filter members 52a and 52b are exposed to the second flow channel 46b, and allowed to be in contact with air flowing through the second flow channel 46b.

According to the circulation filter 50 and the HDD having the above structure, it is possible to manufacture the circulation filter easily at low cost by forming the first and second filter members 52a and 52b integrally. The circulation filter 50 can be easily provided in a guide flow channel 46 of the base 12 by inserting the circulation filter 50 into the fitting grooves 51 of the base 12 from the partition 58 side, in other words, from the bent portion side. Thus, the operation for manufacturing or assembling the HDD can be simplified. In a manner similar to that of the first embodiment, the second embodiment enables the effective surface area of the circulation filter 50 to be increased, and enables the collection efficiency by electrostatic attraction to be improved. In the present embodiment, it is possible to provide a circulation filter (collection filter) having a high efficiency for dust collection, and a disk drive including the circulation filter.

### Third Embodiment

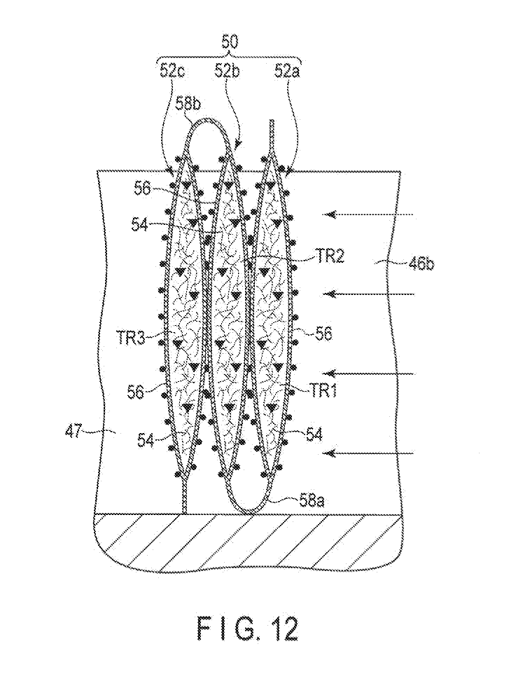

FIG. 11 is a perspective view of a circulation filter of an HDD according to a third embodiment. FIG. 12 is a cross-sectional view of the circulation filter in a fit state.

In the present embodiment, a circulation filter 50 has a structure in which three filter members are connected integrally and are bent at two positions. As shown in FIG. 11 and FIG. 12, the circulation filter 50 is formed by connecting a first filter member 52a, a second filter member 52b, and a third filter member 52c in a line. The first, second, and third filter members 52a, 52b, and 52c include first, second, and third filled areas TR1, TR2 and TR3, respectively, filled with electrostatic fibers such as electret nonwoven fabric 54. The first, second, and third filter members 52a, 52b, and 52c include a common outer envelope 56 which covers the first, second, and third filled areas TR1, TR2, and TR3 and is air permeable. The first, second, and third filled areas TR1, TR2, and TR3 and the outer envelope 56 are formed in a substantially rectangular shape, and are formed in an elongated mat shape as a whole.

The outer envelope 56 includes a first outer envelope 56a which covers a surface side of the first, second, and third filled areas TR1, TR2, and TR3, and a second outer envelope 56b which covers the opposite surface side of the first, second, and third filled areas TR1, TR2, and TR3. The outer envelope 56 is formed in a bag shape by bonding, for example, welding the first and second outer envelopes 56a and 56b together in the outer circumferences of the first, second, and third filled areas TR1, TR2, and TR2. A first partition 58a and a second partition 58b are formed by bonding the first and second outer envelopes 56a and 56b together in a portion located between the first filled area TR1 and the second filled area TR2 and a portion located between the second filled area TR2 and the third filled area TR3. As a result, the first, second, and third filter members 52a, 52b, and 52c are connected to each other by the first and second partitions 58a and 58b. To bend the first and second partitions 58a and 58b easily, perforations or slits 60a and 60b may be formed in the partitions 58a and 58b. As the air-permeable first and second outer envelopes 56a and 56b, resin woven fabric such as polyethylene terephthalate (PET) woven fabric may be used.

As shown in FIG. 12, the circulation filter 50 is bent at the first and second partitions 58a and 58b in opposite directions. The first and second filled areas TR1 and TR2 face each other, and the second and third filled areas TR2 and TR3 face each other. The circulation filter 50 is inserted into or attached to attachment grooves 51 of a base 12 of an HDD from the first partition 58a side or the second partition 58b side in a bent state. Thus, the first, second, and third filter members 52a, 52b, and 52c of the circulation filter 50 are disposed across a second flow channel 46b, and block the second flow channel 46b and an outlet 47. Moreover, the first, second, and third filter members 52a, 52b, and 52c are disposed so as to overlap each other. The center regions of the first, second, and third filter members 52a, 52b, and 52c are in contact with each other. However, the circumferential portions of the filter members face each other with a space therebetween. In this manner, most of the outer envelope 56 of the first, second, and third filter members 52a, 52b, and 52c are exposed to the second flow channel 46b, and allowed to be in contact with air flowing through the second flow channel 46b.

According to the circulation filter 50 and the HDD having the above structure, it is possible to manufacture the circulation filter easily at low cost by forming the first, second, and third filter members 52a, 52b, and 52c integrally. It is possible to further increase the effective surface area of the circulation filter 50 and further improve the collection efficiency by electrostatic attraction by using three filter members.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The material of the circulation filter is not limited to the material described in the above embodiments. Various other materials can be selected. The shape of the circulation filter is not limited to a rectangle. Various shapes can be selected in accordance with the installation space.

In the second embodiment, the number of sets of bent collection filters is not limited to one. A plurality of sets of bent collection filters may be provided so as to overlap with each other. The combination of the collection filter folded in two according to the second embodiment and the collection filter folded in three according to the third embodiment may be employed in an HDD.

What is claimed is:

1. A disk drive, comprising:
a housing;
a disk recording medium disposed in the housing; and
a plurality of filters disposed along a flow channel formed in the housing and overlapped with each other, each of the filters including an outer member formed of an electrostatic woven fabric and electrostatic non-woven fibers contained in an enclosed space formed by the outer member.

2. The disk drive according to claim 1, wherein
each of the filters is in contact with an adjacent filter at a center region thereof.

3. The disk drive according to claim 2, wherein
each of the filters is not in contact with the adjacent filter at non-center regions thereof.

4. The disk drive according to claim 1, wherein
each of the filters includes a first region and a second region that has a thickness smaller than the first region, and is in contact with an adjacent filter at the first region thereof.

5. The disk drive according to claim 4, wherein
each of the filters is not in contact with the adjacent filter at the second region thereof.

6. The disk drive according to claim 1, wherein
the outer member of each of the filters is formed of two members bonded to each other at peripheral regions thereof, such that the enclosed space is formed.

7. A disk drive, comprising:
a housing;
a disk recording medium disposed in the housing; and
a filter disposed along a flow channel formed in the housing, the filter including a plurality of portions overlapped with each other by being folded, each of the portions of the filter including an outer member formed of an electrostatic woven fabric and electrostatic non-woven fibers contained in an enclosed space formed by the outer member.

8. The disk drive according to claim 7, wherein
each of the portions of the filter is in contact with an adjacent portion at a center region thereof.

9. The disk drive according to claim 8, wherein
each of the portions of the filter is not in contact with the adjacent filter at a non-center region thereof.

10. The disk drive according to claim 7, wherein
each of the portions of the filter includes a first region and a second region that has a thickness smaller than the first region, and is in contact with an adjacent filter at the first region thereof.

11. The disk drive according to claim 10, wherein
each of the portions of the filter is not in contact with the adjacent filter at the second region thereof.

12. The disk drive according to claim 7, wherein
the outer members of the filter are integrally formed, and include two members bonded to each other at a peripheral region of each of the portions, such that the enclosed spaces are formed.

13. The disk drive according to claim 7, wherein
the filter is folded along a perforation formed therein.

14. The disk drive according to claim 7, wherein
the filter is disposed in the housing, such that a folded end thereof faces a bottom of the housing.

15. The disk drive according to claim 7, wherein
the filter includes first, second, and third portions arranged along a line in this order and formed from an integral unit,
a first surface of the second portion is in contact with the first portion by folding the integral unit at a boundary between the first and second portions, and
a second surface of the second portion that is opposite to the first surface is in contact with the third portion by folding the integral unit at a boundary between the second and third portions.

16. A filter for a disk drive, comprising:
a first outer member formed of an electrostatic woven fabric;
a second outer member formed of an electrostatic woven fabric, the first and second outer members being bonded with each other such that a plurality of compartments is formed therebetween; and
electrostatic non-woven fibers disposed in each of the compartments.

17. The filter according to claim 16, wherein
a perforation is formed through the first and second outer members between adjacent two of the compartments.

18. The filter according to claim 16, wherein
the compartments include three compartments arranged along a line.
